(19) United States
(12) Patent Application Publication
(10) Pub. No.: US 2011/0216904 A1
(43) Pub. Date: Sep. 8, 2011

(54) METHOD AND APPARATUS FOR IMPROVED SECURE TRANSMISSION BETWEEN WIRELESS COMMUNICATION COMPONENTS

(76) Inventors: Donald J. Kremer, JR., Palm Bay, FL (US); Geoffrey B. Miller, Rockledge, FL (US); Leslie M. Clarkson, Indialantic, FL (US); Ronald J. Capasso, Rockledge, FL (US); Steven L. Iezzi, Melbourne, FL (US)

(21) Appl. No.: 13/127,831

(22) PCT Filed: Nov. 11, 2009
(86) PCT No.: PCT/US09/64046

§ 371 Date: May 5, 2011

Related U.S. Application Data
(60) Provisional application No. 61/113,378, filed on Nov. 11, 2008.

(51) Int. Cl. H04W 12/04

(52) U.S. Cl. 380/270

(57) ABSTRACT

A method for transmitting secured data over a wireless communication network. The method includes transmitting a subframe. The subframe has a preamble, an initialization vector comprising an encrypting key and a burst wherein the burst is encrypted based on the initialization vector and wherein the burst further has a payload and a cyclic redundancy check. The method further includes providing a decrypting key wherein the decrypting key allows the burst to be decrypted.

### CROSS-REFERENCE TO RELATED APPLICATIONS

The present application claims priority to provisional patent application No. 61/113,378 filed Nov. 11, 2008. The present application also claims priority to PCT Application PCT/US09/64046 filed on Nov. 11, 2009 and now published as WO 2010/056756.

### BACKGROUND

The present invention is related to a method and apparatus for secure transmission between wireless communication components. More specifically, the present invention is related to an improved encryption method for secure communications comprising encrypted management data and an initialization vector.

Communication has become a vital part of modern life. Wired transmissions are well known yet they are becoming obsolete in favor or wireless communication. Developing countries have, for the most part, substantially skipped the development of a wired infrastructure in favor of more modern wireless infrastructure.

Any communication linkage between wireless transmitters and receivers is based on a transmission protocol. The protocol dictates the manner in which the data will be transmitted to insure that the transmitter sends the data in such a way that the receiver can receive and interpret the data appropriately. Due to the exponential proliferation of wireless communication devices the protocols have had to evolve to allow the ever increasing amount of information to be transmitted, received and interpreted correctly and efficiently. One such protocol is the series of IEEE 802 wireless protocol which is a series of related protocols for transmission of wireless broadband information. The IEEE 802.16 is a particularly preferred protocol which is also referred to as WirelessMAN™ and commercialized under WiMax which is an acronym for Worldwide Interoperability for Microwave access. An overview of IEEE 802.16 is provided in IEEE STANDARD 802.16: A Technical Overview of the WirelessMAN™ Air Interface for Broadband Wireless Access, Eklund et al., IEEE Communications Magazine, pp 98-107, June 2002; and IEEE Standard 802.16-2004, IEEE Standard for Local and metropolitan area networks—Part 16: Air Interface for Fixed Broadband Wireless Access Systems, Jun. 24, 2004; IEEE 802 Part 16-2005: Air Interface for Fixed and Mobile Broadband Wireless Access Systems Amendment 2: Physical and Medium Access Control Layers for Combined Fixed and Mobile Operation in Licensed Bands and Corrigendum 1 and IEEE 802 Part 16-2009 and Air Interface for Fixed and Mobile Broadband Wireless Access Systems also provide relevant guidance all of which are incorporated herein by reference. A related protocol is Long Term Evolution which is a similar protocol and for the purposes of the present invention will be considered within the IEEE 802 wireless protocols.

The IEEE 802.16 specification, like many others, consists of Media Access Control (MAC) and Physical (PHY) layer specifications. The standard itself has many options throughout the specification which can be combined in various ways. When a set of options is combined to form a system a profile is created. There are many profiles that exist. There is also an organization called WiMax that defines profiles to enable interoperability much like WiFi for IEEE 802.11 or IEEE 820.15 for blue-tooth technology.

The management component of the IEEE 802 wireless is open to the public and allows receivers the ability to determine if a detectable signal is present. The management component describes a number of sublayers which describe the technologies utilized such as Ethernet, ATM, IP, etc. The descriptions are encapsulated on the over-the-air interface. Also included in the MAC is the data classification and information on how the data will be transmitted such as by using secure key exchange during authentication or some form of encryption. It is imperative for a working network that the management component be unencumbered by security overlays such as encryption and the like. If security overlays were incorporated a potential user could not determine the presence of a viable link and therefore could not connect.

The private sublayer is specific to data transmission between a closed set of access points. The private sublayer utilizes a privacy protocol typically based on the Privacy Key Management (PKM) protocol of the DOCSIS BPI+ specification or it may include a cryptographic method such as defined by the Advanced Encryption Standard (AES) or similar standards.

The IEEE 802 wireless standard is an extensive definition of a broadband waveform and MAC protocol for fixed wireless communications and mobile wireless communications as defined in IEEE 802.16-2005. Part of this definition includes multiple mechanisms for the encryption of data at the MAC layer, these definitions exist in both the 802.16-2004 and 802.16-2005 specifications each of which are incorporated herein by reference. The encryption mechanisms only protect data that is contained in the payload portion of IEEE 802 wireless packets, all headers and MAC management packets are sent in the clear per the following text: “Encryption is applied to the MAC PDU payload when required by the selected cipher suite; the generic MAC header is not encrypted. All MAC management messages described in subclause 6.4.2.3 shall be sent in the clear to facilitate registration, ranging, and normal operation of the MAC.” [IEEE802.16-2004]

The advantages of the IEEE 802 wireless protocol are indicated by the worldwide acceptance as a suitable protocol for wireless communications. Unfortunately, the protocol has deficiencies, particularly, with regards to data security.

Due to the mass movement of commerce from a paper based system to an electronic based system there is an ever increasing need for data security. Communication in virtually every area of commerce is now transmitted electronically, and often wirelessly, between various locations and access points. There is now constant transmission of data ranging from financial data, medical records, corporate governance records, treaty negotiations, contract negotiations, covert operation planning and the like most of which is, at least partially, transmitted wirelessly. Due to the installed infrastructure the vast majority of this data transmission is through the world-wide web, intranets, local networks or some combination thereof. The MAC headers and MAC management messages contain information that can be used to determine much information about the wireless network that makes use of IEEE 802 wireless protocol. This information includes, but is not limited to, network addresses, radio node addresses, bandwidth needs, priority of bandwidth needs, ranging information, timing adjustments, power adjustments, and bandwidth adjustments. This information can be used to recreate the entire network by identifying qualities such as node locations, node importance, node information needs, and potentially node command capabilities. While the actual data being transmitted may be protected in some fashion, a potential abuser has sufficient information to determine the presence of the transmission, potentially the value of the transmission, the size of the transmission, etc. so that any effort to break the encryption is focused on high value targets.

This provides any potential abuser with many advantages since they are, at least, able to eliminate a large portion of the communication traffic thereby eliminating task associated with isolating transmissions of interest during intended espionage activities.

One solution to the problem of data piracy and espionage is to use a protocol which is different from the family of IEEE 802 protocols. This technique would be suitable except for the fact that virtually all commercially available equipment including modems, laptops, hubs, etc. are built based on the IEEE 802 wireless protocols. If one attempted to use a non-standard protocol a network would have to be established from the ground up including hardware. This is cost prohibitive in many circumstances. It is therefore desirable to utilize the IEEE 802 wireless protocol and infrastructure built thereon while prohibiting potential theft of underlying management data.

The present invention provides a method for data transmission specifically utilizes the IEEE 802 wireless protocol, and preferably IEEE 802.16, yet does not compromise the data being transmitted or information related to the communication link.

### SUMMARY OF THE INVENTION

The present invention provides a method for allowing a wireless transceiver network to exchange information securely down to the PHY layer of wireless communication protocols. In many wireless protocols encryption exists to encrypt payloads of the protocol packets, while the management messages and MAC layer are left unsecured. An unsecured management layer and MAC headers opens up many security vulnerabilities to include: impersonation attacks, eavesdropping, denial of service, and multiple rogue station attacks. A finite field can be inserted into the transmitted frame structure in the PHY layer. The finite field contains information used in the encryption of the transmitted frame. The finite field is used by the receiving transceiver to decrypt the information upon reception. The use of encryption at the PHY layer provides transmission security for all higher layer communication without incurring measurable latencies.

It is an object of the present invention to provide a method for secure transmission of sensitive data using existing infrastructure.

A particular feature of the present invention is that secure transmission of sensitive data can be transmitted using conventional equipment.

A particular advantage of the instant invention is the undetectability of the presence of a communication link if viewed from a network unless authorized access is provided.

Yet another advantage of the present invention is the ability to transmit sensitive data wherein unauthorized access is thwarted by the presence of an initialization vector upon which encryption of the MAC is based thereby eliminating detection of critical file parameters.

These and other advantages, as will be realized, are provided in a method for transmitting secured data over a wireless communication network. The method includes transmitting a subframe. The subframe has a preamble, an initialization vector comprising encryption information and a burst wherein the burst is encrypted based on the initialization vector and wherein the burst further has a payload and a cyclic redundancy check. The method further includes providing a decrypting key wherein the decrypting key allows the burst to be decrypted.

Yet another embodiment is provided in a system for transmitting secured data over a wireless communication network. The system includes a transmission node capable of forming a subframe. The subframe has a preamble an initialization vector with encryption information and a burst. The burst is encrypted based on an encrypting key and the encryption information. The burst has a payload and a cyclic redundancy check. The system further includes a receiver node capable of receiving the subframe wherein the receiver node comprises a decryption key. The system further includes a wireless network between the transmission node and the receiver node and is capable of transmitting the subframe there between.

### BRIEF DESCRIPTION OF THE DRAWINGS

FIG. 1 is a schematic illustration of the communication protocol.

FIG. 2 is a schematic illustration of an embodiment of the invention.

FIG. 3 is a schematic illustration of an embodiment of the invention.

### DETAILED DESCRIPTION

The present invention is specific to a method for transmitting information which is preferably based on existing IEEE 802 wireless. The method allows secure transmission using existing infrastructure by incorporating management data encryption and an initialization vector containing encryption information within the data transmission.

The invention will be described with reference to the various figures which are presented for the purposes of describing the invention without limit thereto. Throughout the description similar elements will be numbered accordingly.

Specifically, the invention includes a transmission that protects the transmitted frame wherein only a preamble and initialization vector are transmitted without security. The invention uses either a pre-placed-key or a key created via a key exchange and a cipher algorithm to encrypt and decrypt the frame. Examples of cipher algorithms used include but are not limited too: AES (all modes), Data Encryption Standard (DES), Skipjack, Triple DES, and the like. Key length sizes are not limited but can preferably be 64, 96, 128, or 256 bits in length. Length is sometimes limited by the cipher algorithm used. Once the cipher algorithm, initialization vector, and key are applied to the frame, the data is then encrypted. Once the frame is encrypted the information within the frame appears as random data and requires knowledge of the key to successfully decrypt. At the other end of the link the same application is made to decrypt the data. The result is the coverage of the frame except for the preamble and initialization vector. This function can be enabled or disabled on a frame by frame basis, this allows use within an IEEE 802 wireless standard implementation or an enabled implementation.

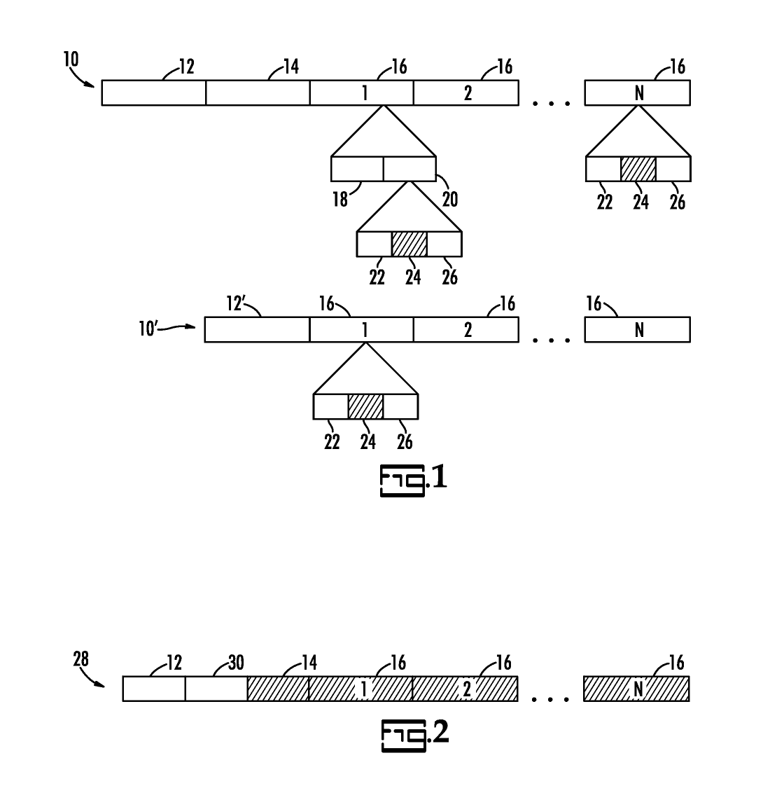

The IEEE 802 wireless protocol will be described with reference to FIG. 1 wherein specific examples are IEEE 802.16; IEEE 802.11; IEEE 802.11; IEEE 802.20 and LTE. In FIG. 1, the data transmission sequence is illustrated schematically with the download subframe, 10, and upload subframe, 10′, illustrated separately. The initial data is a preamble, 12 and 12′. The preamble comprises an acquisition sequence such as multiple repetitions of a set sample size sequence followed by a training sequence of predetermined length. The training sequence is preceded by a cyclic prefix whose length is dependent on the specific operating environment which is typically set to exceed the channel maximum delay spread observed on the channel. The preamble is described, for example, in IEEE 802.16.abc-01/39. With respect to the downlink subframe, 10, a frame control header, 14, follows the preamble. The frame control header specifies the burst profile and length of the download burst which follow.

The download bursts, 16, are a series of data transmissions. Burst 1 of the downlink frame may comprise a broadcast management message, 18, followed by a MAC message, 20, which preferably comprises a MAC header, 22, along with a payload, 24, and cyclic redundancy check, 26. In the IEEE 802 wireless protocol the payload, 24, is encrypted or otherwise protected from unauthorized interpretation.

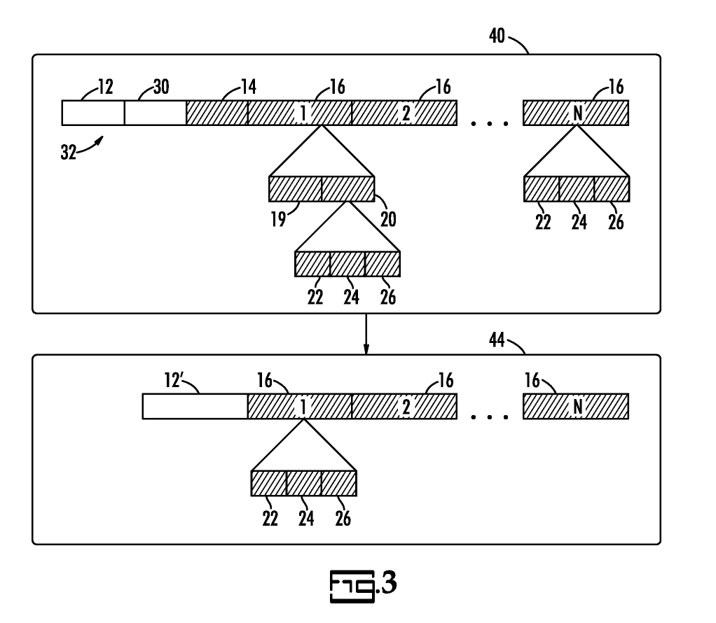

An embodiment of the invention is described with reference to FIG. 2. In FIG. 2 an initialization vector, 30, is inserted into the transmitted frame, 28, at either uplink or downlink, prior to the frame control header, 14. The preamble and initialization vector are not encrypted, however, every component thereafter is encrypted as indicated by dashed lines. Each data burst is encrypted based on an encryption key contained within the initialization vector.

The initialization vector makes the frame incompatible with the IEEE 802 wireless protocol specifications for any frame that it is inserted into. Therefore, non-enabled users will not recognize the transmission if they are using IEEE 802 series of protocols. An enabled receiver would be equipped to recognize the initialization vector and decrypt the data blast at which point the data would be locally treated as if transmitted by the appropriate IEEE 802 wireless protocol.

The invention preferably uses random numbers for the first initialization vector used for transmission. Subsequent initialization vectors are created from the initial initialization vector using a predetermined shift, such as a linear shift of initialization values, to guarantee uniqueness.

The modifications and use of cipher algorithms are made to the PHY and MAC layer. Typically security is applied at the MAC or network layer. This allows high speed processing and greatest achievable coverage of information. MAC and network layer encryption tends to have high latencies and an inability to cover data on lower layers. The implementation makes use of two instantiations of the cipher algorithm, one instantiation is used for the transmission of data, and the second instantiation is used for the reception of data.

In one embodiment the initialization vector uses 88 bits but this can be increased or decreased in size. The number of unique initialization vectors is 2ⁿ transmitted frames in the case of an “n” bit initialization vector. As the number of bits utilized increases the number of unique initialization vectors increases. If the initialization vector is 48 bits in length, for example, and each initialization vector is systematically altered relative to the previous initialization vector in such a way as to prohibit repeats, there would be 2⁴⁸ transmitted frames with each having a unique initiation vector. The number of bits is chosen based on the application. As the number of bits increases the security increases, however, the amount of data transmitted increases which is undesirable. As the number of bits decreases the security decreases, however, the amount data transmitted decreases which is desirable. Therefore, one of skill in the art must optimize between security and data transmission. In practice the number of bits is at least 2 to preferably no more than 1000. Below 2 the security is insufficient and above 1000 the amount of data transmitted is prohibitive. More preferably the number of bits is at least 20 to preferably no more than 200. Even more preferably the number of bits is at least 50 to preferably no more than 300. Particularly preferred are 64, 96, 128 or 256 bits.

Another embodiment of the invention will be described with reference to FIG. 3. In FIG. 3 a transmission node, 40, generates a transmission subframe, 32. The transmission subframe, 32, is transmitted through a network, 42, to a receiver node, 44, wherein the received subframe, 32′, is deciphered. It would be apparent to one of skill in the art that the transmitter node and receiver node are defined as such for the purposes of illustration and each is preferably capable of functioning in either role and typically this is the case. In this embodiment the entire burst, 16, including any broadcast management message, 18, any MAC message, 20, MAC header, 22, payload, 24, and cyclic redundancy check, 26, are encrypted as indicated by the dashed lines. In one embodiment, the receiver would have a physically loaded key for decrypting the transmission. If one attempted to intercept the transmission using IEEE 802 wireless protocol they would not be able to obtain any information contained in the burst nor would they be able to determine the size, duration, transmission start or transmission termination of the burst. This places one attempting to intercept and decipher the message at a significant disadvantage. In another embodiment the data is encrypted based on the initialization vector, 30, which is also transmitted. If the decrypting key is separately provided to the receiver the initialization vector may not be transmitted.

Data may be transmitted by any method known in the art. Digital modulation is most preferable. The data can be divided into parallel data streams or channels with one for each sub-carrier. Each subcarrier is then modulated. The modulation technique can be done by Binary Phase-Shift Keying (BPSK), Quadrature Phase-Shift Keying (QPSK), higher order phase shift keying or Differential Phase Shift Keying (DPSK). Alternatively, the transmission may be done by Amplitude-Shift Keying (ASM) or Frequency-Shift Keying (FSK). The particular method of data transmission may be Orthogonal Frequency-Division Multiplexing (OFDM), Coded Orthogonal Frequency-Division Multiplexing (COFDM), Discrete Multi-tone Modulation (DMT) or Frequency Division Mulitiplexing (FDM).

Cryptography is well known. In general, cryptography includes modifying a transmission by an algorithm. A key, which is shared by the transmitter and receiver, is necessary to decrypt the transmitted data. The key can be a symmetrical key an asymmetrical key. With a symmetrical key the key used to encrypt the message and the key used to decrypt the message are the same. With an asymmetrical key the key used to encrypt the message is different than that used to decrypt the message. It is most common to have a public key and a private key wherein one is most preferably not derivable from the other. The key may be exchanged using a key exchange algorithm commonly referred to as an Internet Key Exchange (IKE). A suitable, non-limited, example is a Diffie-Hellman key exchange such as the improved version IKEv2. Other key exchange algorithms could be employed without deviating from the invention.

The method of randomization is not particularly limited herein with pseudo-randomization being less preferred due to the inherent weaknesses. Methods which are exemplary include hashing techniques such as MD5 and Secure Hash Algorithm (SHA-1) both of which are well known and readily available.

The invention has been described with particular reference to the preferred embodiments without limit thereto. One of skill in the art would realize additional embodiments without departure from the invention which is set forth in the claims appended hereto.

Claimed is:

1. A method for transmitting secured data over a wireless communication network comprising:
transmitting a subframe wherein said subframe comprises:
a preamble;
an initialization vector comprising encryption information; and
a burst wherein said burst is encrypted based on said encryption information and wherein said burst comprises:
a payload; and
a cyclic redundancy check; and
providing a decrypting key wherein said decrypting key allows said burst to be decrypted.

2. The method for transmitting secured data over a wireless communication network of claim 1 wherein said decrypting key is transmitted within said subframe.

3. The method for transmitting secured data over a wireless communication network of claim 1 wherein said decrypting key is resident on a receiver node.

4. The method for transmitting secured data over a wireless communication network of claim 1 wherein said burst further comprises a frame control header.

5. The method for transmitting secured data over a wireless communication network of claim 1 wherein said preamble and said initialization vector are not encrypted.

6. The method for transmitting secured data over a wireless communication network of claim 1 wherein said initialization vector is 2ⁿ bits in length wherein n is selected from 2 to 1000.

7. The method for transmitting secured data over a wireless communication network of claim 6 wherein said initialization vector is 2ⁿ bits in length wherein n is selected from 50 to 300.

8. The method for transmitting secured data over a wireless communication network of claim 7 wherein said initialization vector is 2ⁿ bits in length wherein n is selected from 64, 96, 128, and 256 bits.

9. The method for transmitting secured data over a wireless communication network of claim 1 wherein said subframe is communicated based on IEEE 802 wireless protocol.

10. The method for transmitting secured data over a wireless communication network of claim 9 wherein said IEEE 802 protocol is selected from IEEE 802.11 protocol; IEEE 802.16 protocol; IEEE 802.20 protocol and LTE.

11. The method for transmitting secured data over a wireless communication network of claim 1 wherein said blast is encrypted with an algorithm selected from DES, AES, Triple DES and skipjack.

12. The method for transmitting secured data over a wireless communication network of claim 1 wherein said decrypting key is transmitted by a key exchange algorithm.

13. The method for transmitting secured data over a wireless communication network of claim 12 wherein said key exchange algorithm is selected from the group consisting of IKE, IKEv2, a Diffie-Hellman based mechanism and an elliptical key generation scheme.

14. The method for transmitting secured data over a wireless communication network of claim 1 wherein said initialization vector comprises at least one component selected from a random component, a time-of-day component and a sequential data component.

15. The method for transmitting secured data over a wireless communication network of claim 1 wherein sequential initialization vectors are related by a linear shift.

16. The method for transmitting secured data over a wireless communication network of claim 1 further comprising decrypting all data except for the physical layer synchronization pattern and the initialization vector.

17. The method for transmitting secured data over a wireless communication network of claim 1 further comprising entering said initialization vector and said key descriptor into a cipher algorithm.

18. The method for transmitting secured data over a wireless communication network of claim 1 further comprises an AES counter feedback mode algorithm in at least one layer selected from a receive chain of a physical layer and a transmit chain of said physical layer.

19. A system for transmitting secured data over a wireless communication network comprising:
a transmission node capable of forming a subframe comprising:
a preamble;
an initialization vector comprising encryption information; and
a burst wherein said burst is encrypted based on said encryption information and wherein said burst comprises:
a payload; and
a cyclic redundancy check; and
a receiver node capable of receiving said subframe wherein said receiver node comprises a decryption key; and
a wireless network between said transmission node and said receiver node capable of transmitting said subframe there between.

20. The system for transmitting secured data over a wireless communication network of claim 19 wherein said decrypting key is resident on said receiver node.

21. The system for transmitting secured data over a wireless communication network of claim 19 wherein said burst further comprises a frame control header.

22. The system for transmitting secured data over a wireless communication network of claim 19 wherein said preamble and said initialization vector are not encrypted.

23. The system for transmitting secured data over a wireless communication network of claim 19 wherein said initialization vector is 2ⁿ bits in length wherein n is selected from 2 to 1000.

24. The system for transmitting secured data over a wireless communication network of claim 23 wherein said initialization vector is 2ⁿ bits in length wherein n is selected from 50 to 300.

25. The system for transmitting secured data over a wireless communication network of claim 24 wherein said initialization vector is 2ⁿ bits in length wherein n is selected from 64, 96, 128, and 256 bits.

26. The system for transmitting secured data over a wireless communication network of claim 19 wherein said network transmits data based on an IEEE 802 protocol.

27. The method for transmitting secured data over a wireless communication network of claim 26 wherein said IEEE 802 protocol is selected from IEEE 802.11 protocol; IEEE 802.16 protocol and IEEE 802.20 protocol.

28. The system for transmitting secured data over a wireless communication network of claim 19 wherein said initialization vector comprises at least one component selected from a random component, a time-of-day component and a sequential data component.
